(19) United States
(12) Patent Application Publication
(10) Pub. No.: US 2026/0096570 A1
(43) Pub. Date: Apr. 9, 2026

(54) EDIBLE COATINGS AND METHODS FOR DELAYING GREENING IN POTATOES

(71) Applicants: University of Guelph, Guelph (CA); EarthFresh Farms Inc., Burlington (CA)

(72) Inventors: Yuyang ZHANG, Guelph (CA); Jeannine BONILLA, Guelph (CA); Loong-Tak LIM, Guelph (CA); Caihua SHI, Burlington (CA); Winnie CHIU, Burlington (CA)

(21) Appl. No.: 19/349,554

(22) Filed: Oct. 3, 2025

Related U.S. Application Data
(60) Provisional application No. 63/703,500, filed on Oct. 4, 2024.

(51) Int. Cl. A23B 7/154; A23B 7/16; A23L 19/12

(52) U.S. Cl. CPC A23B 7/154; A23B 7/16; A23L 19/12

(57) ABSTRACT

Described are various embodiments of methods for delaying greening in potatoes. In one embodiment, the method comprises preparing a coating-forming solution comprising at least one edible polymer dissolved in a compatible solvent. Edible polymers may include proteins, polysaccharides or a combination thereof. Proteins may include prolamin proteins such as zein, gluten, glutenin, gliadin, hordeins, avenins, secalins, or karifin. Polysaccharides includes cellulose derivatives including hydroxypropyl methylcellulose (HPMC), carboxymethylcellulose, or methylcellulose. The compatible solvent may include a single solvent composition or a blend of solvent compositions, for example water-soluble alcohol. An effective amount of coating-forming solution is applied on the surface of the potato, and dried to form an edible coating. The edible coating comprises a coating body configured to, at least in part, reduce the availability of molecular oxygen, and/or scatter light.

### CROSS REFERENCE TO RELATED APPLICATIONS

This application claims priority from U.S. Provisional Patent Application No. 63/703,500, filed on Oct. 4, 2024, the disclosure of which is hereby incorporated herein in its entirety by reference.

### FIELD OF THE DISCLOSURE

The present disclosure relates to polymer-based edible coating, and, in particular, to methods for delaying greening in potatoes.

### BACKGROUND

One of the main causes of potato tuber quality loss is the greening defect, characterized by the green discoloration of the outer surface of whole or processed potatoes during storage, especially when exposed to light. Greening can occur at any stage along the supply chain; therefore, managing losses due to this defect represents a major challenge for both growers and retailers.

Potato tubers are non-photosynthetic underground-modified stems filled with amyloplasts, these being colorless plastids responsible for the synthesis and storage of starch (Tanios et al., 2018; Larsen & Molteberg, 2023). While amyloplasts are colourless, light exposure causes the amyloplasts to differentiate into chloroamyloplasts in the cortical parenchyma tissue, directly beneath the periderm. The rate of amyloplasts to chloroplasts conversion depends on light intensity, wavelength, and exposure duration. Concurrent with this greening phenomenon, light exposure also induces the formation of glycoalkaloids (e.g., chaconine, solanine, solasonine and tomatine) via a biochemical pathway independent of the greening process (Slanina, 1990; Petermann & Morris, 1985). Glycoalkaloids are beneficial in the defence system of the potato plants against insect pests/pathogens; however, they are toxic to humans at elevated concentrations and can cause severe health issues (e.g., diarrhea/vomiting, disrupt cell membranes, inhibition of cholinesterase). Moreover, glycoalkaloids also introduce undesirable bitterness in potatoes, even after cooking (Bushway & Ponnampalam, 1981). An acceptable level of glycoalkaloids in potatoes should be less than 200 mg/kg fresh weight (Friedman, 2006; Bamberg, Mochninsi, Navarre, & Suriano, 2015). Other factors that determine the prevalence of greening include potato variety, tuber physiological age, post-harvest storage conditions, packaging materials, chemical treatment, and so on (Tanios, Eyles, Tegg, & Wilson, 2018).

Various post-harvest strategies have been applied to mitigate the greening defect in potatoes. For example, since the absorbance maxima for chlorophyll synthesis are 475 and 675 nm, while the solanine and chaconine are 430 and 650 nm, respectively (Petermann & Morris, 1985), greening defects at the retail level can be avoided by shielding the potatoes from electromagnetic radiations of wavelength in the regions 400-500 nm (violet to blue) and 620-680 nm (red) are of special interest (Larsen & Molteberg, 2023). Alternatively, opaque packaging structures, such as paper/paperboard, metalized films, multilayer laminate, and so on, are used. While these light-blocking packaging materials are effective, the packaged potato products are not visible to the consumers and/or they do not reveal the natural coloration of potatoes. These issues are undesirable for the ready-to-cook product category, where product visibility at the retail level is critical from a marketing and sales perspective.

Other approaches to inhibit potato greening involve treating the tuber surfaces with surfactants (e.g., Tween 60-85, glycerin), wax (e.g., paraffin wax), edible oils (e.g., peanut oil, corn oil, olive oil, mineral oil and vegetable oil) (Gericke, 1956; Poapst & Forsyth, 1978; Maga & Fitzpatrick, 1980; Wu & Salunkhe, 1972). Studies also showed that pretreatment with several chemical compounds such as Sequesterene Na₂Cu, Sequesterene Na₄, Chelate 600 NaFe, and copper gluconate; ethylene-diamine tetra-acetic acid, can have positive effect on inhibiting greening (Gull, & Isenberg, 1958; Kitzke, 1962). However, these solutions have limited efficacy and/or negatively impacted product quality attributes, such as the development of oxidative rancidity and off-flavour, in addition to causing consumer acceptance issues due to health concerns with the use of synthetic chemicals.

Modified atmosphere packaging of potato tubers with low oxygen levels has been shown to reduce chlorophyll formation and control potato greening (Banks, 1985; Forsyth & Eaves, 1968; Patil, Singh, & Salunkhe, 1971). However, this approach requires optimized packaging barrier properties to establish the target headspace oxygen and carbon dioxide concentrations. Moreover, the respiration rate of the crop is temperature-dependent; temperature fluctuation will perturbate the headspace gas equilibria. The physiological age of the crops, variety, and other factors will also affect the efficacy of the modified atmosphere packaging approach to address the greening issues.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for methods to delay greening in potatoes, as well as edible coating compositions that achieve this effect. This contributes to extending the shelf life of potatoes while maintaining their visual appearance and ensuring safety for consumption.

In accordance with one aspect, there is provided a method for delaying greening in a potato, comprising the steps of: preparing a coat-forming solution comprising at least one edible polymer dissolved in a compatible solvent with a total concentration ranging from 0.1 to 10% (w/w), wherein the at least one edible polymer comprises polysaccharides, proteins, or any combination thereof; applying an effective amount of the coat-forming solution on a surface of the potato; and drying the effective amount of the coat-forming solution on the surface of the potato to form an anti-greening edible coating.

In some embodiments, the coat-forming solution comprises a polysaccharide and a protein.

In some embodiments, the polysaccharides are selected from a group consisting of: hydroxypropyl methylcellulose (HPMC), carboxymethylcellulose, methylcellulose, starch, alginate, chitosan, or pullulan.

In some embodiments, the proteins are selected from a group consisting of: zein, gluten, glutenin, gliadin, hordeins, avenins, secalins, or karifin.

In some embodiments, the compatible solvent comprises water, alcohol, or any combination thereof.

In some embodiments, the alcohol is selected from the group comprising ethanol, isopropanol, glycerol, propylene glycol, or 1,3-butylene glycol.

In some embodiments, the alcohol is selected based on an ability to deactivate enzymes involved in a chlorophyll synthesis pathway.

In some embodiments, the coat-forming solution undergoes at least a partial phase separation when drying.

In some embodiments, the coat-forming solution further comprises at least one food-grade additive that inhibits, at least in part, sprouting in potato tubers.

In some embodiments, the applying comprises dipping the potato into the coat-forming solution.

In some embodiments, the applying comprises spraying the coat-forming solution on the potato.

In some embodiments, the applying is completed within 12 hours after the potato is first exposed to light.

In some embodiments, the drying is completed at room temperature.

In some embodiments, the anti-greening edible coating is transparent.

In some embodiments, the anti-greening edible coating has a thickness ranging from about 0.5 μm to about 20 μm.

In accordance with another aspect, there is provided a food product for preventing greening of a potato comprising: an anti-greening edible coating formed by applying and drying, on a surface of the potato, an effective amount of a coat-forming solution comprising at least one edible polymer dissolved in a compatible solvent with a total concentration ranging from 0.1 to 10% (w/w), wherein the at least one edible polymer comprises polysaccharides, proteins, or a combination thereof.

In some embodiments, the coat-forming solution comprises a polysaccharide and a protein.

In some embodiments, the polysaccharides are selected from a group consisting of: hydroxypropyl methylcellulose (HPMC), carboxymethylcellulose, methylcellulose, starch, alginate, chitosan, or pullulan.

In some embodiments, the proteins are selected from a group consisting of: zein, gluten, glutenin, gliadin, hordeins, avenins, secalins, or karifin.

In some embodiments, the compatible solvent comprises water, alcohol, or any combination thereof.

In some embodiments, the alcohol is selected from the group comprising ethanol, isopropanol, glycerol, propylene glycol, or 1,3-butylene glycol.

In some embodiments, the alcohol is selected based on an ability to deactivate enzymes involved in a chlorophyll synthesis pathway.

In some embodiments, the coat-forming solution further comprises at least one food-grade additive that inhibits, at least in part, sprouting in potato tubers.

In some embodiments, the anti-greening edible coating is transparent.

In some embodiments, the anti-greening edible coating has a thickness ranging from about 0.5 μm to about 20 μm.

In some embodiments, the anti-greening edible coating based on the combination of the polysaccharides and the proteins comprises a self-stratified coating of a plurality of edible polymers.

In some embodiments, the anti-greening edible coating provides a gas barrier that, at least in part, reduces the availability of molecular oxygen for biosynthesis of chlorophyll precursors.

In some embodiments, the anti-greening edible coating, at least in part, scatters light.

In some embodiments, the anti-greening edible coating, at least in part, provides partial coverage of lenticels or temporary disruption of lenticels.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

The patent or application file contains at least one color photograph. Copies of this patent or patent application publication with color photographs will be provided by the Office upon request and payment of the necessary fee.

Several embodiments of the present disclosure will be provided, by way of examples only, with reference to the appended drawings, wherein:

FIG. 1 shows scanning electron micrographs of zein/HPMC films at different polymer ratios (Z: zein; H: HPMC (hydroxypropyl methylcellulose); zein and HPMC ratios are on weight basis), in accordance with one embodiment;

FIG. 2 shows confocal fluorescence images of different ratios of zein/HPMC film solutions with Nile red, wherein the red color signifies zein particles (Z: zein, H: HPMC (hydroxypropyl methylcellulose), zein and HPMC ratios are on weight basis), in accordance with one embodiment;

FIG. 3 shows atomic force microscopy images of top and bottom surface of zein: HPMC films with different ratios (Z: zein; H: HPMC (hydroxypropyl methylcellulose); zein and HPMC ratios are on weight basis), in accordance with one embodiment;

FIG. 4 shows ATR-FTIR spectra of bottom and top surface of zein: HPMC films with different ratios (Z: zein; H: HPMC (hydroxypropyl methylcellulose); zein and HPMC ratios are on weight basis; T: top surface; B: bottom surface), in accordance with one embodiment;

FIG. 5 shows photographs of uncoated and coated potatoes with treatment A in a first storage period (treatment A: 3:2 Z:H; Z: zein; H: hydroxypropyl methylcellulose), in accordance with one embodiment;

FIG. 6 shows photographs of uncoated and coated potatoes with treatment B in a second storage period. (treatment B: 4:1 Z:H; Z: zein; H: hydroxypropyl methylcellulose), in accordance with one embodiment;

FIG. 7 shows cross-section photographs of uncoated and coated potatoes with treatment A in a first storage period (treatment A: 3:2 Z:H; Z: zein; H: hydroxypropyl methylcellulose), in accordance with one embodiment;

FIG. 8 shows cross-section photographs of uncoated and coated potatoes with treatment B in a second storage period (treatment B: 4:1 Z:H; Z: zein; H: hydroxypropyl methylcellulose), in accordance with one embodiment;

FIG. 9 is a graphical plot of UV-vis scanning spectra of edible films from treatments A and B in the electromagnetic radiation of 200 nm to 700 nm wavelength range (treatment A: 3:2 Z:H; treatment B: 4:1 Z:H; Z: zein; H: hydroxypropyl methylcellulose), in accordance with one embodiment;

FIG. 10 shows cross section and surface morphologies of uncoated (I and II) and coated potato peels with treatment A (III and IV) (treatment A: 3:2 Z:H; Z: zein; H: hydroxypropyl methylcellulose), in accordance with one embodiment;

FIG. 11 shows cross section and surface morphologies of uncoated (I and II) and coated potato peels with treatment B (III and IV) (treatment B: 4:1 Z:H; Z: zein; H: hydroxypropyl methylcellulose), in accordance with one embodiment;

FIG. 12 shows photographs of uncoated and coated potatoes with an anti-greening edible coating with various pre-light exposure durations on day 0 and day 14, in accordance with one embodiment; and

FIG. 13 is a bar chart of greening index data associated with uncoated and coated potatoes with an anti-greening edible coating with various pre-light exposure durations in 2 weeks of ambient storage, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The present disclosure is directed to, in accordance with different embodiments, the treatment of raw, unpeeled, cold-stored potato tubers exposed to different light conditions to prevent potato skin greening using anti-greening polymer-based edible coatings. Also disclosed is a method of preparation of the anti-greening polymer-based edible coatings, in accordance with different embodiments.

Edible coating is an integral part of a product with specific purposes, such as protecting it from undesirable ambient factors (e.g., oxygen, moisture, light), carrying bioactives (e.g., antimicrobial, antioxidant, nutraceutical, nutrient), imparting desirable product characteristics (e.g., color, texture), preventing product aggregation/adhesions, shelf-life extension of fresh produce, and so on (Aider, 2010; Dutta, Tripathi, Mehrotra, & Dutta, 2009; Galus & Kadzińska, 2015; Amoozegaran, Dehghan, Homami, & Hashemi, 2022; Sapper & Chiralt, 2018; Yadav et al., 2022; Jung et al., 2020; Kumar, Mukherjee, & Dutta, 2020; Trinh, Smith, & Mekonnen, 2022; Kuorwel, Cran, Orbell, Buddhadasa, & Bigger, 2015). Due to their edible and functional properties, polysaccharides and proteins are among the most commonly used polymers for coating applications. For example, hydroxypropyl methylcellulose (HPMC), a cellulose derivative, is used as edible coating due to its non-ionic, cost-effective, optical transparency, flexibility, and gas barrier properties (Sánchez-González, Vargas, González-Martínez, Chiralt, & Cháfer, 2009). Zein, a prolamin protein derived from the corn meal by-product of the corn starch, edible oil, and bioethanol industry (Shukla & Cheryan, 2001; Lawton, 2002), is insoluble in water but soluble in aqueous 70-80% ethanol (Hassan, Chatha, Hussain, Zia, & Akhtar, 2018; Gennadios, McHugh, Weller, & Krochta, 1994) Zein coatings have lower water vapor permeability and less moisture-sensitive than protein-based counterparts-a property ideal for moisture barrier application. However, zein coating is brittle and hence unsuitable for applications when flexibility and toughness are important (Bourtoom, 2009; Tsai & Weng, 2019).

To exploit the mechanical and barrier properties of different polymers in a single structure, multi-layer composite coatings are typically formed by sequential deposition of two or more distinct layers. Alternatively, self-stratification, a concept involving the preparation of a multi-functional structure from a single formulation in one application step, may be used, resulting in the formation of two distinct layers upon drying (Carr, 1990; Funke, 1976; Verkholantsev, 1995). This approach relies on phase separation of two or more incompatible polymers dissolved in a common solvent made up of two or more compounds of different volatility. Because of the different compatibility of the polymers and solvent constituents, phase separation occurs during the drying process. The characteristics of the resulting stratified structure depend on the polymer composition and solvent vapor pressure. According to the scheme presented by Toussaint (1996), the morphologies of the stratified coating can be categorized into four types. Type I exhibits distinct layers. Type II is characterized by a concentration gradient through the film thickness between the stratified levels. Type III is composed of isolated spherical phases with various sizes of one polymer, which are uniformly dispersed in the continuous matrix of the other polymer. In type IV, the dispersed phases tend to coalesce to form islands or isthmuses.

Considering that HPMC is soluble in water and up to 70% aqueous ethanol, but zein is soluble in 70-80% aqueous ethanol, and that ethanol has a higher vapor pressure (5.8 kPa at 20° C.) than water (2.3 kPa at 20° C.) (PubChem, retrieved on Feb. 21, 2020), aqueous ethanol could be used as a common solvent for zein and HPMC to formulate coat-forming solution that self-stratifies into distinct polymer phases upon drying. Since ethanol will evaporate more rapidly than water during the drying process, the water-compatible phase will tend to partition in the remaining water-rich phase, while zein tend to migrate towards the surface of the coating, forming a zein-rich top layer.

During experiments involving coating formulations composed of zein and HPMC blends, it was found that applying zein-HPMC coatings to the surface of whole potatoes led to an unexpected inhibition of greening defects. This effect was observed when the potato samples were exposed to environmental conditions that would otherwise induce rapid greening discoloration. Additionally, distinctive microstructures within the coating layer were identified, which may have contributed to the anti-greening properties observed in the coated potato tubers.

### Section I: Characterization of Zein-HPMC Films

### Materials and Methods

### Materials:

Zein was obtained from Flo Chemical Corporation (Ashburnham, MA, USA). HPMC was purchased from Sigma-Aldrich, Inc. (St. Louis, MO, USA) with a methyl content of 28-30% and a hydroxypropyl content of 7-12%. USP grade anhydrous ethyl alcohol was supplied by Greenfield/Global-Commercial Alcohols (Brampton, ON, Canada).

### Process to Prepare Zein/HPMC Based Film-Forming Solutions:

The HPMC solution (1.0% or 4.0% w/w; 28-30% and 7-12% methyl and hydroxypropyl contents, respectively; Sigma-Aldrich, Inc., St. Louis, MO, USA) was prepared by adding HPMC powder to 70% (w/w) aqueous ethanol and stirring for 1 h by using a mechanical stirrer (AGITATOR, Arrow Engineering Co., Hillside, NJ, USA) at room temperature. Separately, zein powder (Flo Chemical Corporation (Ashburnham, MA, USA) was added to 70% (w/w) aqueous ethanol and stirred for 30 min with the magnetic stirrer (SP88857100, Thermo Scientific, Waltham, MA, USA) at room temperature to form a 4.0% w/w solution. The zein solution was centrifuged at 9279 g for 30 min (IEC 21000 Centrifuge, International Equipment Co., Needham, MA, USA) followed by decanting the solution from the centrifuge tube to remove the undissolved polymer. Taking the undissolved zein into account, the final concentration of zein was about 2.0% (w/w). The HPMC and zein solutions were then blended at different ratios.

### Scanning Electron Microscopy (SEM) Analysis:

The cross-section morphology of zein/HPMC films were analyzed by SEM (FEI Quanta FEG 250 SEM, Thermo Fisher Scientific, Hillsboro, OR, USA) at an accelerating voltage of 20 kV and high vacuum of 5.13×10⁻⁶ mbar. The cryo-fracture was applied to reveal the natural morphology of the cross-sections. Briefly, the samples were vacuum sealed in bags to prevent moisture condensation from air, and then submerged in liquid nitrogen for 2 min. The bags were removed and immediately snapped with two pairs of tweezers. The samples were mounted on the 90° metal stubs and coated with a layer of gold (˜20 nm) using a sputter coater (Denton Desk V TSC, Denton Vacuum LLC, Moorestown, NJ, USA).

### Spinning Disk Confocal Microscopy:

The protein phase was identified using spinning disk confocal microscopy (Quorum Technologies, Puslinch, ON, CA), equipped with a Leica DMi8 microscope and Volocity software (version 6.3). Samples with different ratio of zein:HPMC were dissolved in 200 mL water containing 30 μL of 1 mg/mL Nile Red and stirred at 400 rpm for 12 h. The dyed polymer solutions were placed on concave slides, the fluorescent dyes were excited at 488 nm to identify the protein phase of the samples.

### Particle Size Distribution:

Particle size distributions of zein particle suspensions were monitored by static light scattering (Mastersizer 3000, Malvern Instrument Ltd., Malvern, UK). Particle sizes were measured by dissolving 100 mg of zein/HPMC film samples in 200 mL deionized water and stirring for 12 h at room temperature (20 to 22° C.) to disperse the zein particles into water. The samples were diluted in deionized water and stirred at 2000 rpm until the obscuration rate reached 3-5%. The refractive index and absorption index of zein used were 1.49 and 0.001, respectively. Surface mean diameter (D_{3,2}) parameter was calculated from particles size profiles according to eq. 1 (ASTM, 2020):

$${D}_{3.2} = \frac{\sum {n}_{i} {d}_{i}^{3}}{\sum {n}_{i} {d}_{i}^{2}} \qquad ( 1 )$$

where nᵢ is the number of particles of a determined size range, and di is the particle diameter.

### Attenuated Total Reflection (ATR) Fourier-Transform Infrared (FTIR) Spectroscopy:

The FTIR spectra were recorded using an FTIR spectrometer (IRPrestige21, Shimadzu Corporation, Kyoto, Japan) fitted with an ATR accessory (Pike Technologies, Madison, WI, USA) to elucidate component interactions in the composite film samples. The scan range was 4000-600 cm⁻¹, the resolution of the spectrometer was 4 cm⁻¹ and an average of 32 scans was performed for each sample.

### Atomic Force Microscopy (AFM):

The surface topographies of the films were analyzed by atomic force microscopy (Anasys Instruments, Santa Barbara, CA, USA) in tapping mode with a silicon nitride probe cantilever (SPM Probe Model: ACTA Part #ACTA-10, APPNANO, Mountain View, CA, USA). A tapping frequency of 310 kHz was employed, and films were scanned at speed of 0.5 Hz. Phase images and height images with scan sizes of 10 μm×10 μm were acquired to analyze the roughness of films.

### Thickness and Mechanical Properties:

Film thickness was measured at different positions by a digital micrometer (Testing Machines Inc, Amityville, NY, USA) and an average of ten values was calculated. The mechanical properties of films including tensile stress (TS, MPa), elasticity (elongation at break) (EAB, %), and Young's modulus (YM, MPa) were determined using an Instron Universal Testing Machine (Instron Co., Canton, MA, USA) equipped with a 5 kN load cell according to ASTM standard method D882-18 (ASTM, 2018). The films were cut into rectangular strips of 25.4 mm×100 mm and loaded between the grippers. The initial gauge length was 80 mm and then deformation speed was 25 mm/min. Ten measurements were performed for each sample.

### Water Vapor Permeability (WVP):

The WVP was evaluated following the ASTM standard method E 96M—05 (ASTM, 2005) with some modifications. The films were fixed to the permeability cups with 25 cm² exposed area which contained anhydrous calcium chloride. The cups were kept at 24° C. in a hermetically sealed container containing saturated sodium chloride solution to maintain 75% RH and weighed every 4 h. WVP (g mm kPa⁻¹ h⁻¹ m⁻²) values were calculated by eq. 2:

$$W V P = Δ w \times L / A Δ t Δ P \qquad ( 2 )$$

where L is the film thickness (m); Δw is the weight gain of the cup after time interval Δt (h); Δt is the measuring time interval (h); A is the exposed area of film (m²); ΔP is the saturation vapor pressure of water (2.4 kPa; assuming 0% interior headspace RH) at 22° C.

### Opacity and Color:

The films were cut into the size of 2×2 cm², and then measured at 200-800 nm wavelengths to determine the UV-Vis light transmittance using a UV-Vis spectrophotometer (3607 Pasco Scientific, Roseville, CA, USA). The opacity of films was calculated according to eq. 3:

$$Opacity = - log {T}_{600} / d \qquad ( 3 )$$

where T₆₀₀ is the fractional transmittance at 600 nm and d is the film thickness (mm).

Film color was determined by the Chroma Meter (CR-400 Meter Konica Minolta, Ramsey, NJ, USA) at room temperature. The L* (lightness), a* (redness/greenness), and b* (yellowness/blueness) were obtained for different films. The instrument was calibrated with a white reflector standard plate with standard values (L=95.13, a=0.00 and b=1.47). The total difference in color (ΔE*) was calculated according to eq. 4:

$$Δ E *= \sqrt{{{{( Δ L \text{*)}}^{2} + ( Δ a \text{*)}}^{2} + ( Δ b \text{*)}}^{2}} \qquad ( 4 )$$

where ΔL*, Δa* and Δb* represent the differences between the corresponding color parameter of the samples and that of the white standard.

### Data Analysis:

All experimental data were analyzed by one-way analysis of variance (ANOVA) with SPSS software and expressed as means±standard deviations (n=3). Duncan's multiple tests were used to determine the significance of differences (p<0.05) between treatments.

### Results and Discussion

### Microscopy Analyses and Film Morphology:

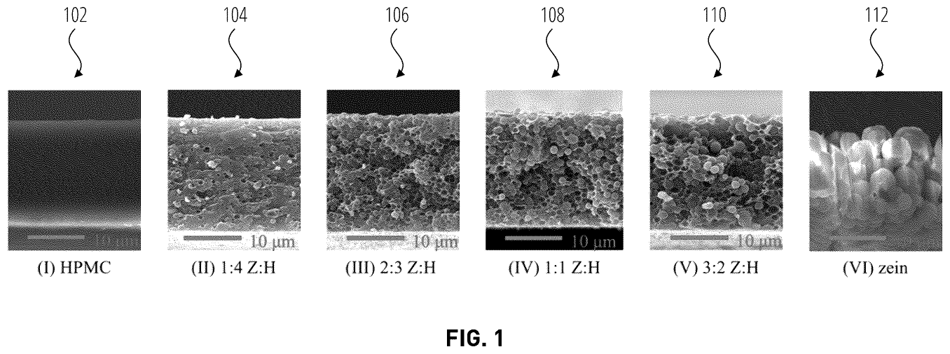

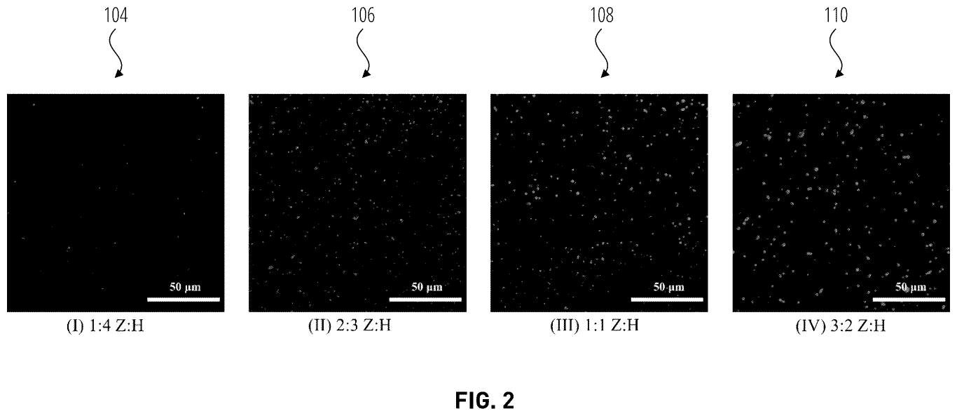

Film specimens prepared from 4:1 zein: HPMC (w/w) were not uniform and were excluded from further analysis. The neat zein film was brittle and readily cracked when handled, so it was used for SEM, AFM and FTIR analyses but not in mechanical and barrier tests. FIG. 1 shows scanning electron micrographs of zein/HPMC films at different polymer ratios, in accordance with one embodiment. The different polymer ratios tested include a neat HPMC film 102, a 1:4 Z:H film 104, a 2:3 Z:H film 106, a 1:1 Z:H film 108, a 3:2 Z:H film 110, and a neat zein film 112. SEM results showed that the cross-section of the neat HPMC film 102 displayed a uniform and smooth morphology (FIG. 1. I). With the addition of zein, phase separation occurred between zein and HPMC during the drying process, forming submicron spherical particles that were homogeneously distributed in the composite films 104, 106, 108, 110 (FIG. 1.II-V). The size of particles in the cross-section micrographs of the composite films increased with increasing zein concentration. Type III phase separation was obtained in this research, wherein Type III phase separation, as described by Toussaint (1996), involves stratified coating composed of isolated spherical phases with various sizes of one polymer, which are uniformly dispersed in the continuous matrix of the other polymer. One noteworthy feature on the micrographs is the presence of hollow cavities. These are likely the sites previously occupied by the spherical entities that were dislodged when the specimens were fractured to reveal the cross-sections for SEM analysis. This observation, along with the smooth surface textures of the spheres, suggests that the sphere and continuous phases had weak interfacial adhesion. To confirm the distribution of zein in the composite films 104, 106, 108, 110, the relatively hydrophobic protein phase was selectively stained with Nile red. The spherical particles were identified as being composed of the hydrophobic proteins (FIG. 2). The particle size and number of particles increased as a function of the zein content from 20 to 60%. The zein particle diameter ranged between 1 to 3 μm, which is consistent with the SEM micrographs (FIG. 1).

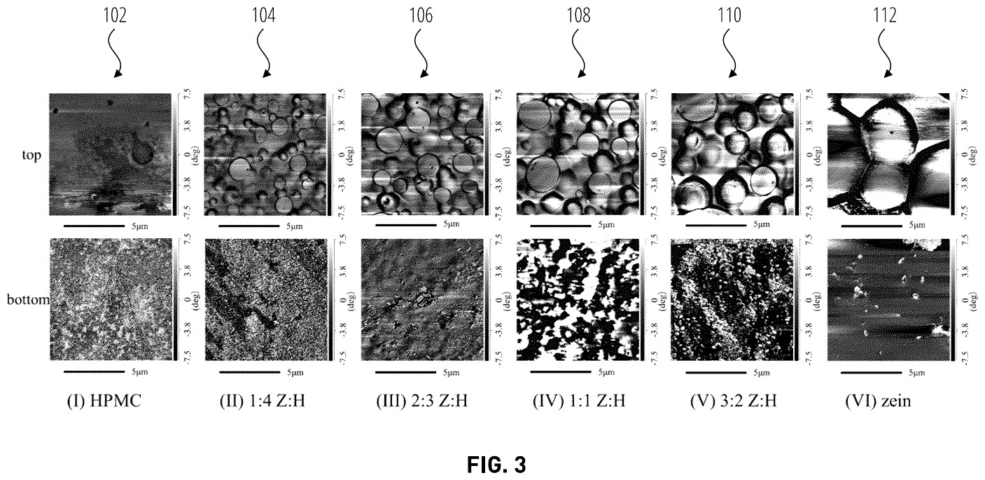

To better understand the film surface morphologies, AFM micrographs of the top and bottom surfaces of the tested films 102, 104, 106, 108, 110, 112 were obtained (FIG. 3). The presence of zein in the composite films 104, 106, 108, 110 led to an increase in surface roughness as compared to the neat HPMC film 102. As reflected by the average roughness (Ra) and root-mean-square roughness (Rq) values (Table 1), the neat HPMC film 102 had a smoother and more homogenous surface (top surface: Ra=4.97 nm, Rq=9.41 nm; bottom surface: Ra=1.23 nm, Rq=1.70 nm) as compared with the composite films 104, 106, 108, 110. The Rq and Ra values for both surfaces increased with increasing zein content, with bottom surface roughness values tended to be lower than those of the top surfaces. The preferential migration of zein particles to the top surface might have contributed to the increased top surface roughness.

TABLE 1
Average roughness (Ra) and root-mean-square roughness (Rq) of
top and bottom surface of different ratio of zein:HPMC (Z:H)
films, wherein the samples are identified as: Z: zein, H: HPMC
(hydroxypropyl methylcellulose). Zein and HPMC ratios are on
the weight basis. Data, followed by their standard deviations,
are means of eight experiments. Different letters in the same
column indicate significant difference (p < 0.05).

| | |
|---|---|
| Top surface | Bottom surface |

| Samples | Ra (nm) | Rq (nm) | Ra (nm) | Rq (nm) |
|---|---|---|---|---|
| 0:1 Z:H | 4.97 ± | 9.41 ± | 1.23 ± | 1.70 ± |
| | 1.26^{e} | 0.58^{d} | 0.11^{e} | 0.14^{d} |
| 1:4 Z:H | 86.02 ± | 106.15 ± | 7.10 ± | 8.95 ± |
| | 7.55^{de} | 10.13^{cd} | 0.28^{d} | 0.21^{d} |
| 2:3 Z:H | 142.18 ± | 174.84 ± | 14.18 ± | 18.85 ± |
| | 22.96^{cd} | 26.67^{bc} | 3.15^{c} | 2.89^{c} |
| 1:1 Z:H | 187.66 ± | 227.72 ± | 21.48 ± | 30.35 ± |
| | 17.58^{c} | 26.80^{c} | 1.51^{b} | 2.98^{b} |
| 3:2 Z:H | 283.2267 ± | 338.55 ± | 24.74 ± | 32.68 ± |
| | 20.33^{b} | 32.68^{b} | 1.61^{b} | 4.26^{b} |
| 1:0 Z:H | 603.88 ± | 798.32 ± | 30.34 ± | 49.93 ± |
| | 119.60^{a} | 139.00^{a} | 0.01^{a} | 4.29^{a} |

### Zein Particles Size Distribution:

The zein particle size distribution is shown in Table 2. The D_{3,2} values of zein particles increased significantly from 0.84 to 2.02 μm, as zein content increased from 20 to 60% in composite films. Consistent with the SEM and confocal fluorescence analyses, the zein particle size increased with increasing zein content. In the film-forming solution, the total polymer content of zein and HPMC was fixed, i.e., when the zein content increased, HPMC concentration decreased. As the zein content increased, besides promoting the growth of larger zein particles, the reduction of HPMC phase might have also reduced the apparent viscosity of film-forming solution, thereby facilitating the molecularly diffusion of zein to promote particles growth.

TABLE 2
Surface mean diameters (D_{3, 2}) of zein in zein:HPMC (Z:H)
films, wherein zein and HPMC ratios are on the weight
basis. Data, followed by their standard deviations, are
means of eight replicates. Different letters in the same
column indicate significant difference (p < 0.05).

| Sample | 1:4 Z:H | 2:3 Z:H | 1:1 Z:H | 3:2 Z:H |
|---|---|---|---|---|
| D_{3, 2} (μm) | 0.84 ± | 1.19 ± | 1.46 ± | 2.02 ± |
| | 0.01^{d} | 0.01^{c} | 0.06^{b} | 0.01^{a} |

### ATR-FTIR Analysis:

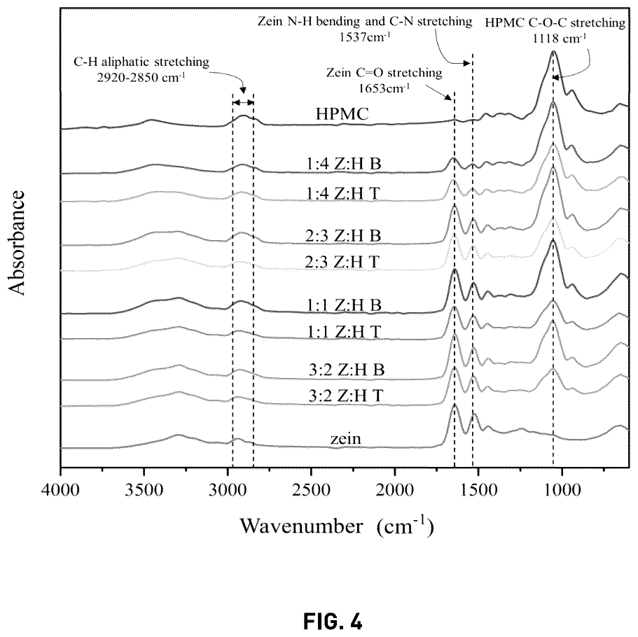

The FTIR spectra of HPMC film 102, zein film 112 and HPMC/zein films 104, 106, 108, 110 are shown in FIG. 4, wherein Z: zein, H: HPMC (hydroxypropyl methylcellulose), B: bottom surface, T: top surface, zein and HPMC ratios are on the weight basis. For pure HPMC films, the inherent C—O—C stretching vibration of glucopyranose was observed at 1118 cm⁻¹ (Van Ngo et al., 2016). The peaks around 1400 cm⁻¹ were bending vibration of-OH groups of HPMC and C—H bending vibration (amide III) (Aman Mohammadi et al., 2021). The absorbance at 1537 cm⁻¹ was related to the N—H bending and C—N stretching vibration of amide II. The peak at 1653 was attributed to C═O stretching vibration known as amide I peak of zein protein. The C—H aliphatic stretching vibrations were observed at 2920-2850 cm⁻¹ (Ghasemi, Miri, Najafi, Tavakoli, & Hadadi, 2022). The band around 3450 cm⁻¹ position can be attributed to the stretching mode of the —OH group in HPMC and N—H and O—H stretching of amino acid in zein (Aman Mohammadi et al., 2021). The peak intensity at 1118 cm⁻¹ for the bottom surfaces of the film specimens was stronger than that of the top surface of the composite films, implying that the concentration of HPMC was higher than zein in the bottom surface. In contrast, the peak intensity at 1537 and 1653 cm⁻¹ of the top surface of the films was stronger than that of the bottom surface, implying the higher zein concentration than HPMC concentration in the top surface. This observation can be attributed to the migration of zein with ethanol towards the top surface of the coating solution during film drying, while HPMC tended to partition to the water-rich phase near the bottom surface. When zein and HPMC were mixed in different ratios, the FTIR spectra showed the characteristic peaks of the respective polymers, but peak shifts were not detected, implying minimal zein-HPMC interactions. These observations are in accordance with the SEM micrographs (FIG. 1), which revealed weak interfacial adhesion between the dispersed zein and continuous HPMC phases.

### Mechanical and Barrier Properties of Composite Films:

Thickness, TS, EAB and YM values of composite films with different zein ratios are summarized in Table 3. All films had comparable thickness values, ranging from 22.40±1.17 μm (HPMC) to 23.30±1.34 μm (2:3 zein: HPMC), indicating that the addition of zein did not cause significant (p>0.05) changes in the film thickness. Increasing zein content from 0:1 to 2:3 zein: HPMC content increased the YM value from 27.45±0.74 MPa to a maximum of 30.53±0.96 MPa, suggesting the added zein reinforced the HPMC matrix, thereby increasing the stiffness of the biocomposite (Gilbert, Cheng, & Jones, 2018). However, a significant decrease in YM was observed with further increase of zein content. On the other hand, both TS and EAB values decreased with increasing zein content (Table 3), suggesting that the zein spherical particles lowered the strength and reduced the film extensibility of the composite films. The weakening of zein-HPMC composite can be attributed to the minimal zein-HPMC interaction (FIG. 4) and weak interfacial adhesion between the zein-HPMC phases (FIG. 1), in addition to the disruption of the continuous HPMC matrix as the volume of added zein particles increased (Gilbert et al., 2018).

The WVP of zein: HPMC composite films were compared in Table 3. In terms of barrier properties, neat HPMC film had the highest WVP (1.79×10⁻⁴ g·m/m²·h·kPa). By increasing zein ratio in the films, WVP decreased from 1.70 to 1.14×10⁻⁴ g·m/m²·h·kPa from 20 to 60% zein content. The increased moisture barrier can be attributed to the relatively more hydrophobic nature of zein relative to HPMC.

TABLE 3
Mechanical and barrier properties of zein:HPMC (Z:H) films, wherein
EAB: elongation at break; TS: tensile stress; YM: Young's modulus;
Z: zein, H: HPMC (hydroxypropyl methylcellulose), Zein and HPMC
ratios are on the weight basis. Data, followed by their standard
deviations, are means of eight experiments. Different letters in
the same column indicated significant difference (p < 0.05).

| | | | | | WVP |
|---|---|---|---|---|---|
| | | | | | (10⁻⁴ |
| | Thickness | | | | g · m/m² · |
| Samples | (μm) | EAB (%) | TS (MPa) | YM (MPa) | h · kPa) |
| 0:1 Z:H | 22.40 ± | 14.88 ± | 62.35 ± | 27.45 ± | 1.79 ± |
| | 1.17^{a} | 2.14^{a} | 4.53^{a} | 0.74^{bc} | 0.02^{a} |
| 1:4 Z:H | 23.00 ± | 5.55 ± | 54.13 ± | 30.26 ± | 1.70 ± |
| | 0.82^{a} | 0.96^{b} | 2.09^{b} | 1.10^{a} | 0.01^{b} |
| 2:3 Z:H | 23.30 ± | 3.15 ± | 50.12 ± | 30.53 ± | 1.55 ± |
| | 1.34^{a} | 0.37^{c} | 2.27^{bc} | 0.96^{a} | 0.01^{c} |
| 1:1 Z:H | 22.80 ± | 2.79 ± | 47.45 ± | 28.30 ± | 1.29 ± |
| | 0.92^{a} | 0.18^{c} | 2.49^{c} | 1.36^{b} | 0.05^{d} |
| 3:2 Z:H | 22.60 ± | 1.89 ± | 33.65 ± | 26.28 ± | 1.14 ± |
| | 0.97^{a} | 0.24^{c} | 3.78^{d} | 1.03^{c} | 0.02^{e} |

### Color and Opacity of Films:

The color and opacity of films are two important indices because they have a direct impact on the appearance of the product and its consumer acceptance. L*, a*, b*, ΔE*, and opacity values are presented in Table 4. The neat HPMC films showed the lowest value of ΔE* (0.113), and this value significantly (p<0.05) increased with increasing zein content. L* and a* values decreased significantly (p<0.05), but the b* value increased significantly (p<0.05) as a function of zein concentration in the composite films. The 3:2 zein: HPMC film showed the highest greenness and yellowness values. The increasing coloration of films was due to a minor fraction of xanthophylls and carotenoids in commercial zein powder resulting in yellow pigmentation (Sessa, Eller, Palmquist, & Lawton, 2003). Lower opacity indicates a higher film transparency. The opacity of HPMC film was 1.61 mm⁻¹, and significantly (p<0.05) increased with increasing zein concentration. When the zein ratio was up to 50% (w/w), there was no significant (p<0.05) increase in the opacity of films. The opacity would be attributed to the presence of zein particles in the matrix, increasing light scattering by the composite films (Gilbert et al., 2018).

TABLE 4
Color parameters and opacity of different ratios of zein:HPMC
(Z:H) films, wherein Z: zein, H: HPMC (hydroxypropyl methylcellulose),
zein and HPMC ratios are on the weight basis. Data, followed
by their standard deviations, are means of ten experiments.
Different letters in the same column indicated significant
difference (p < 0.05).

| | Color | | | | Opacity/ |
|---|---|---|---|---|---|
| Sample | L* | a* | b* | ΔE* | mm⁻¹ |
| 0:1 Z:H | 95.10 ± | −0.01 ± | 1.56 ± | 0.113 ± | 1.61 ± |
| | 0.01^{a} | 0.02^{a} | 0.06^{e} | 0.05^{e} | 0.16^{a} |
| 1:4 Z:H | 95.00 ± | −1.10 ± | 5.62 ± | 4.50 ± | 14.77 ± |
| | 0.04^{b} | 0.09^{b} | 0.34^{d} | 0.35^{d} | 0.47^{b} |
| 2:3 Z:H | 94.82 ± | −1.93 ± | 9.76 ± | 8.52 ± | 33.82 ± |
| | 0.05^{c} | 0.02^{c} | 0.17^{c} | 0.17^{c} | 0.68^{c} |
| 1:1 Z:H | 94.54 ± | −2.43 ± | 11.99 ± | 10.82 ± | 37.47 ± |
| | 0.04^{d} | 0.04^{d} | 0.22^{b} | 0.22^{b} | 1.78^{d} |
| 3:2 Z:H | 94.06 ± | −3.00 ± | 15.17 ± | 14.07 ± | 38.34 ± |
| | 0.16^{e} | 0.11^{e} | 0.62^{a} | 0.64^{a} | 1.64^{d} |

### Section II: Edible Coating to Inhibit Greening of Potatoes

### Materials and Methods

### Formulations:

The HPMC solution (1.0% or 4.0% w/w) and zein solution (4.0% w/w) were prepared as described in Section I. For treatment A, 4% HPMC was blended with 4% zein at 2:3 weight ratio. For treatment B, 1% HPMC was mixed with 4% zein at 1:1 weight ratio. Both solutions were allowed to equilibrate at 20-23° C. for 12 h prior to coating the potatoes.

### Application of Zein/HPMC Coating:

The organic Laperla potatoes were obtained from EarthFresh Farms Inc. in September 2023. Tubers without visible damage were washed with running water and dried at 20° C. and 50% relative humidity (RH). All potatoes were stored at 8° C. in darkness for 60 d to break the dormancy. Afterwards, potatoes without sprout or greening defects were selected and coated with treatments A and B. As is known, zein coating exhibits moisture barrier properties but lacks flexibility and toughness. In the present disclosure, HPMC was added to improve optical transparency, flexibility, and gas barrier properties.

For potatoes with treatment A, the specimens were placed in the environmental growth chamber (MLR-350H, Sanyo Electric Co., Ltd. Japan) at 22° C. and 75% RH with 12 h dark and 12 h light everyday light exposure (cool white, fluorescent lamp, 37 Watt, Sanyo FL40SS.W/37, Sanyo, Japan) for 14 d (a first storage period), and located 20 cm away from the potato experiment. The relevant physicochemical properties of these potatoes were measured every 7 d. For coated potatoes with treatment B, control and treated samples were stored at 22° C. and 75% RH with 24 h light exposure (cool white, fluorescent lamp, 32 Watt, Philips F32T8/TL741, Massachusetts, USA) for 12 d (a second storage period), and located 1.5 m away from the potato samples. The quality attribute changes of these potatoes were measured every 4 d.

### Color and Visual Appearance:

The potato color in terms of L* and a* values was determined using Chroma Meter (CR-400 Meter Konica Minolta, Ramsey, NJ, USA). Before measuring, the colorimeter was calibrated with white tile provided with the instrument with the L* and a* values of 95.13 and 0.00, respectively. Three places of each sample and the average values were recorded. Moreover, the visual appearances of potatoes were taken by a digital camera (Canon SX 400 is, Canon Solutions America, Melville, NY, US).

### UV-Vis Spectrophotometry:

The coating solutions were cast on a glass plate with controlled thickness (3 to 5 μm) and were then dried at 20° C. and 75% RH for 12 h to form the thin films. Samples were peeled from the glass plates and stored at 20° C. and 50% RH for 48 h for further analysis. The thin films were collected and subjected to UV-vis spectrophotometry (GENESYS 50, Thermo Fisher Scientific, Madison, WI, US) for the acquisition of spectra profiles (200-700 nm). Each specimen was scanned three times.

### Scanning Electron Microscopy (SEM):

The surface and cross-section morphology of zein/HPMC coated potato peels were analyzed by scanning electron microscopy (FEI Quanta FEG 250 SEM, Thermo Fisher Scientific, Hillsboro, OR, USA) at an accelerating voltage of 20 kV and at 5.13×10⁻⁶ mbar vacuum. The cryo-fracture was applied to reveal the natural morphology of the potato peels. The samples were mounted on the 90° metal stubs and completely dried for 24 h in room condition before coating with a layer of gold (˜20 nm) using a sputter coater (Denton Desk V TSC, Denton Vacuum LLC, Moorestown, NJ, USA).

### Results and Discussion

### Color and Visual Appearance:

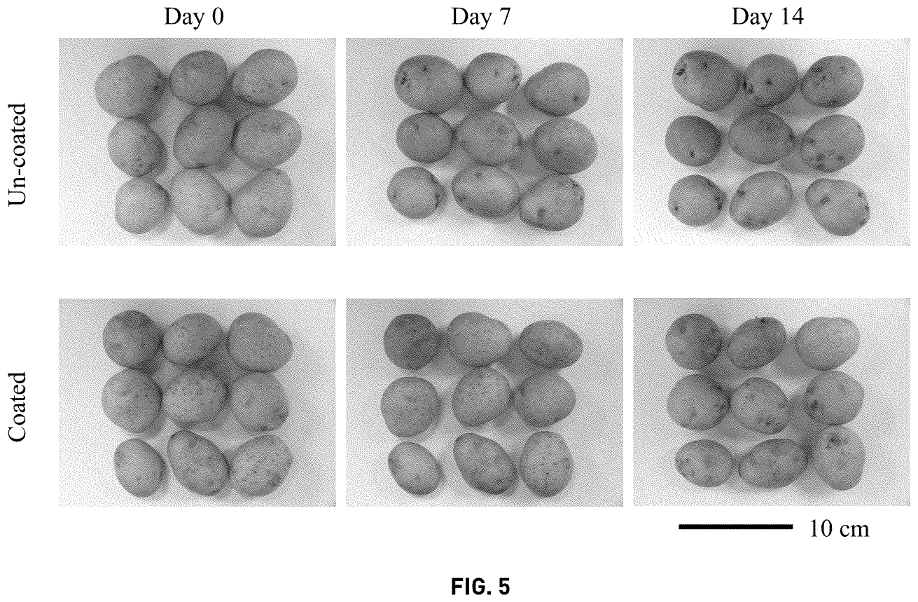

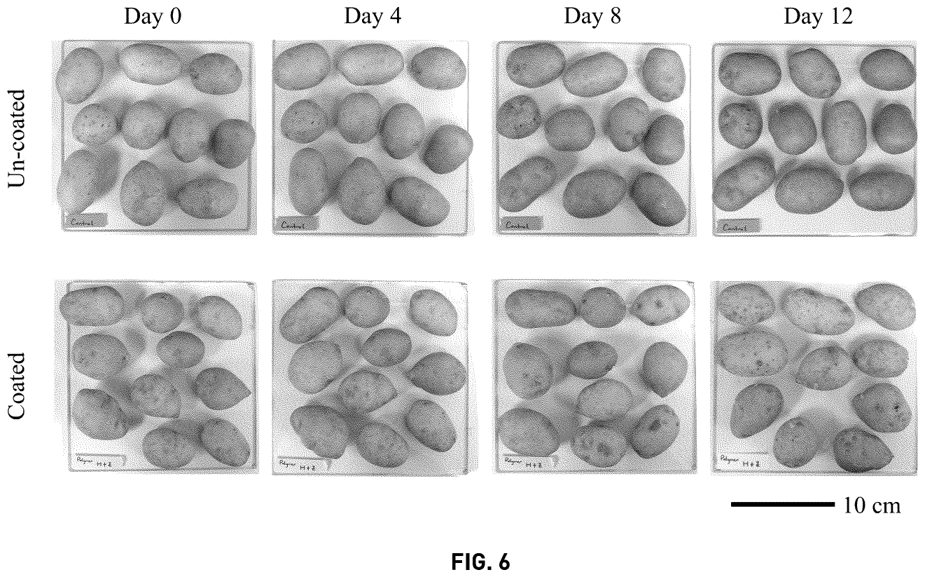

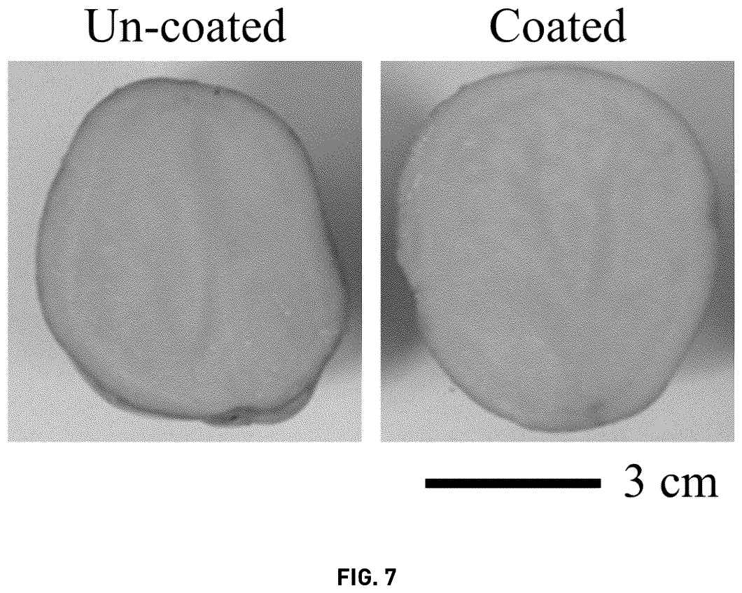

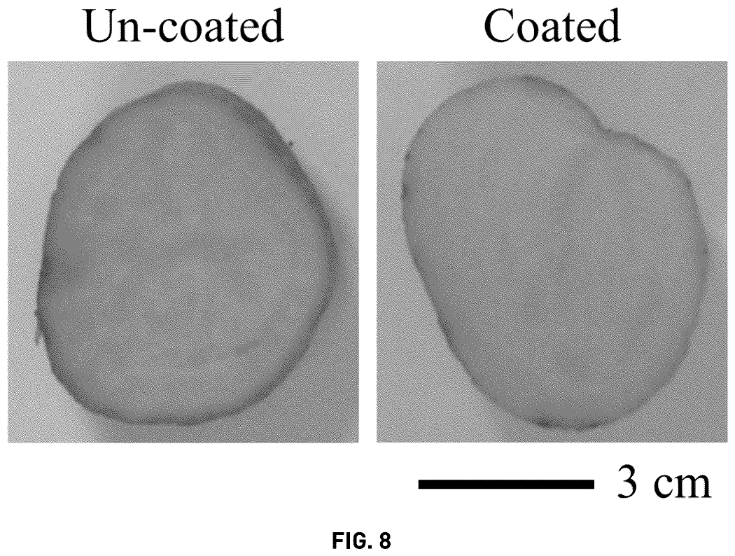

The visual color changes of potato tubers stored for treatments A and B are presented in FIG. 5 and FIG. 6, respectively. The application of edible coating preserved the original color of the potato skin, and no greening phenomenon was observed during storage. Moreover, no visual differences were observed between the potatoes coated with treatments A and B up to 14 d of storage. On the other hand, the uncoated potatoes had a noticeable exterior green coloration on the 7 or 8 d of storage. Moreover, as shown in FIG. 7 and FIG. 8, the cross-section of uncoated potatoes had green coloration around the cortical parenchyma below the periderm, of around 1 to 1.5 mm depth from the surfaces.

Colorimetric analysis showed that the a* value (from green to red) and L* value (from white to black) of potatoes are presented in Tables 5 and 6, respectively. For treatment A, the a* value decreased (p<0.05) from 2.78 to −2.02 for the uncoated potatoes compared to the coated potatoes, which remained around 2.0 throughout the 14 d of storage. In addition, L* value of coated potatoes was around 63, whereas the L* of uncoated potatoes was 58.19 (Table 5). For treatment B, a* value showed a significant (p<0.05) decrease from 3.79 to −2.44 for the uncoated potatoes compared to the coated potatoes, which remained unchanged at around 4.0 throughout the 12 d storage. Moreover, the L* value of coated potatoes decreased from 65.79 to 62.03 compared to uncoated potatoes, which decreased from 66.35 to 55.73 at the end of the study (Table 6).

TABLE 5
L* and a* values of uncoated and coated potatoes with treatment A
in a first storage period (14 d), wherein treatment A: 3:2 Z:H;
Z: zein; H: hydroxypropyl methylcellulose. Data, followed by their
standard deviations, are means of ten experiments. Different letters
in the same row indicated significant differences (p < 0.05).

| | Color | Time (d) | | |
|---|---|---|---|---|
| Sample | value | 0 | 7 | 14 |
| Uncoated | L* | 64.99 ± 2.46^{a} | 60.96 ± 2.85^{b} | 58.19 ± 2.54^{c} |
| Coated | | 65.36 ± 2.53^{a} | 64.06 ± 2.47^{ab} | 62.95 ± 2.42^{b} |
| Uncoated | a* | 2.78 ± 0.08^{a} | −0.08 ± 0.09^{b} | −2.02 ± 0.66^{c} |
| Coated | | 2.62 ± 0.05^{a} | 2.59 ± 0.38^{a} | 2.21 ± 0.07^{a} |

TABLE 6
L* and a* values of uncoated and coated potatoes with treatment B
in a second storage period (12 d), wherein treatment B: 4:1 Z:H;
Z: zein; H: hydroxypropyl methylcellulose. Data, followed by their
standard deviations, are means of ten experiments. Different letters
in the same row indicated significant differences (p < 0.05).

| | |
|---|---|
| Color | Time (d) |

| Sample | value | 0 | 4 | 8 | 12 |
|---|---|---|---|---|---|
| Uncoated | L* | 66.35 ± | 61.69 ± | 57.84 ± | 55.73 ± |
| | | 3.18^{a} | 1.20^{b} | 2.05^{c} | 1.58^{d} |
| Coated | | 65.79 ± | 65.32 ± | 63.02 ± | 62.03 ± |
| | | 0.99^{a} | 2.28^{a} | 2.45^{a} | 1.00^{a} |
| Uncoated | a* | 3.79 ± | −0.23 ± | −2.42 ± | −2.44 ± |
| | | 0.25^{a} | 0.02^{b} | 0.50^{c} | 0.93^{c} |
| Coated | | 3.90 ± | 4.59 ± | 4.49 ± | 4.96 ± |
| | | 0.59^{a} | 0.22^{a} | 0.46^{a} | 0.84^{a} |

### UV-Vis Spectrophotometry:

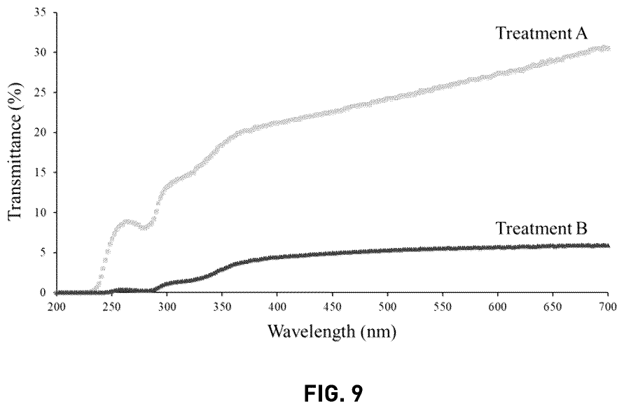

The transmittance spectra of edible films from treatments A and B are presented in FIG. 9, revealing the optical properties throughout the visible light wavelength range. The transmittance of treatment A varied between 20-30%, indicating a moderate level of transparency. The film from treatment B had a transmittance value of approximately 5%, suggesting a higher degree of opacity than treatment A. Both films retained a degree of transparency to reveal the potato surface morphology important for consumer acceptance of the product. The partial transparency of the coating layers in both treatments implies that they can be utilized in potato applications to maintain visual clarity.

### Microscopy Analyses and Film Morphology:

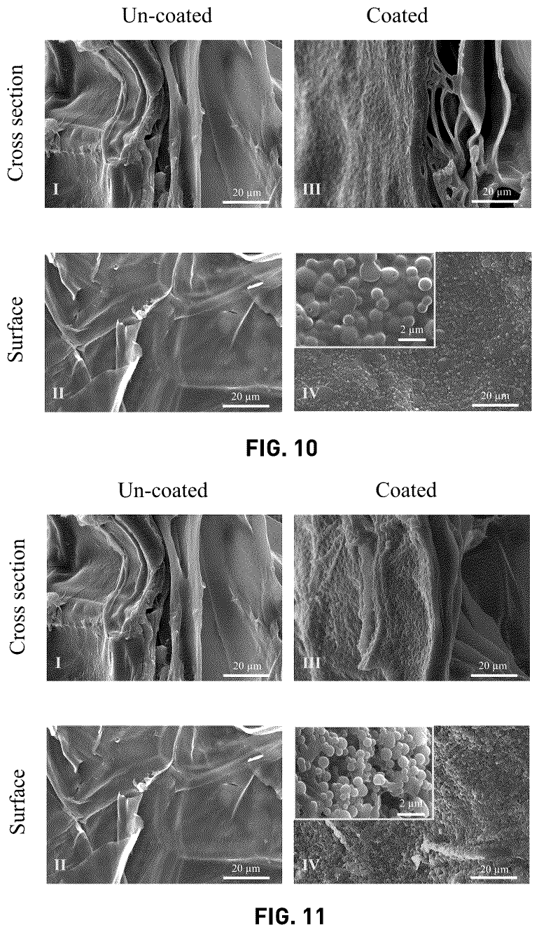

The surface and cross-section morphology of the uncoated and coated potato peels with treatment A and treatment B observed by SEM are shown in FIG. 10 and FIG. 11, respectively. The periderm of potato tubers is a layer of suberized and starch-free dead cells, which is immediately adjacent to multi-layers of cortical parenchyma tissue (Dourado et al., 2019; Miranda & Aguilera, 2006). The coating with the homogenous zein particles in continuous HPMC was evenly spread and fixed on the potato peels for treatment A (FIGS. 10 III and IV) and treatment B (FIGS. 11 III and IV). These particles may have scattered the light to prevent the greening of potatoes. These observations suggested that edible coating is desirable to prevent the greening of potatoes. The zein-HPMC edible coating developed in the present study could be promising for treating potatoes to inhibit greening and extend their shelf-life.

### Section III: Influence of Pre-Light Exposure on Coating Efficiency

### Materials and Methods

### Potato Samples and Storage Conditions:

Mini potatoes (˜25 mm) diameter covered with soil were obtained from EarthFresh Farms Inc. (Burlington, ON, Canada) and collected from storage coolers maintained at 8° C. for 2 d. Following collection, tubers were washed with tap water and air-dried overnight (15 h) at room temperature in darkness.

### Application of Coating:

Prior to treatment, tubers with visible physical damage or discoloration were excluded. The coating formulation consisted of 0.75% (w/w) HPMC, 0.05% (w/w) zein, 60% (w/w) ethanol, and the remainder tap water. Potatoes were immersed in the solution for 10 s, allowed to drip for an additional 10 s, then placed on wire racks to dry for 8 min at room temperature (around 20-22° C.).

Tubers were randomly assigned into five experimental groups (70 potatoes per group):
1. Control 1202: uncoated potatoes exposed to light at the beginning of the study.
2. 0 h pre-light exposure 1204: coated potatoes exposed to light immediately after treatment (no pre-light exposure).
3. 12 h pre-light exposure 1206: potatoes pre-exposed to light for 12 h prior to coating, followed by continuous light storage.
4. 24 h pre-light exposure 1208: potatoes pre-exposed to light for 24 h prior to coating.
5. 36 h pre-light exposure 1210: potatoes pre-exposed to light for 36 h prior to coating.

After treatment, all groups were stored under continuous light at ambient conditions.

### Measurements:

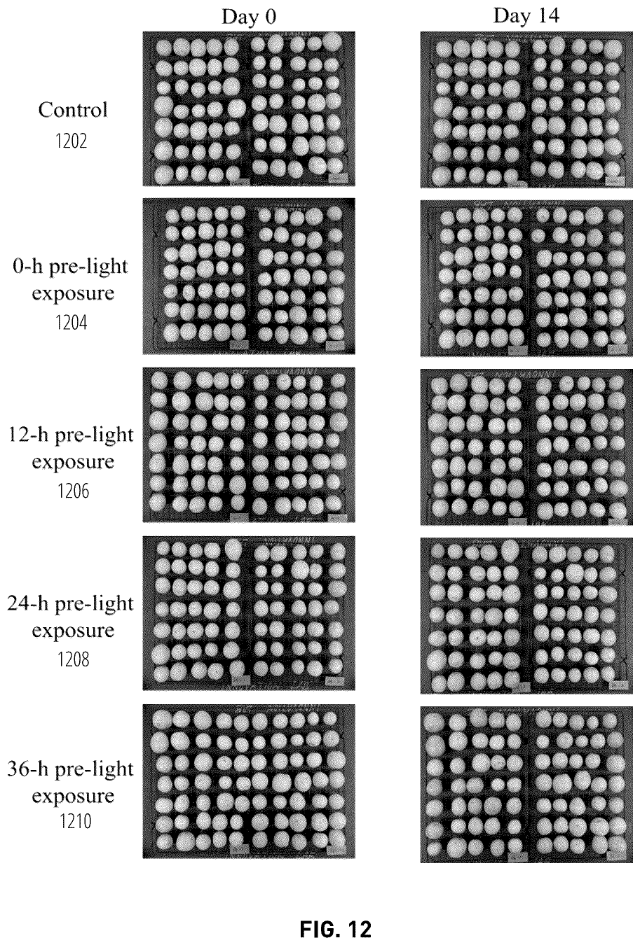

Photographs were taken at regular intervals to monitor the skin color of the potatoes, as shown in FIG. 12. Visual inspection was conducted to assess greening, and the greening index was calculated as the percentage of tubers within each group that developed visible greening.

### Statistical Analysis:

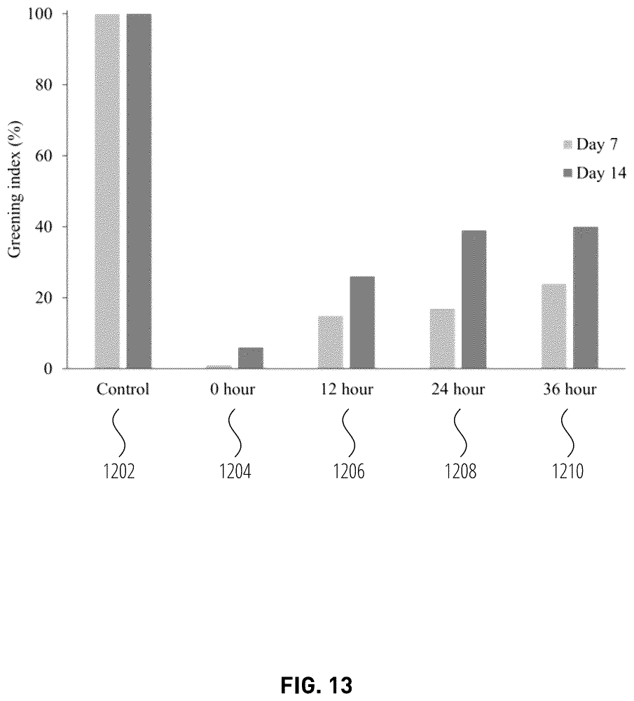

Greening index data were expressed as percentages. The proportion of green tubers in each group was compared across time points as shown in FIG. 13.

### Results and Discussion

Effect of pre-light exposure: FIG. 12 and FIG. 13 showed that all uncoated control potatoes exhibited visible greening after 1 week of storage. By contrast, the 0 h group showed only 1 green tuber at week 1 (day 7) and 4 tubers at week 2 (day 14), with markedly lighter greening compared to controls. When potatoes were pre-exposed to light before coating, greening incidence increased in proportion to pre-exposure duration. In the 12 h group, 10% and 26% of tubers showed greening after 1 and 2 weeks, respectively. In the 24 h group, greening incidence increased to 17% after 1 week and 40% after 2 weeks. The 36 h group exhibited 24% greening at week 1 and 40% by week 2. These findings demonstrate that pre-light exposure significantly compromises coating efficacy, with a clear threshold effect beyond 12 h of exposure. Optimal anti-greening performance was achieved when coating was applied within 12 h of light exposure as it reduces visible greening by at least 90% relative to uncoated controls after two weeks of storage with continuous light exposure.

### Effect of Polymer Concentration:

The coating in this study contained a substantially lower total polymer concentration (0.8% w/w) compared to the formulations used in Section II as described herein (4% w/w). Due to the lower total polymer concentration, the coating may have a thickness of at least 0.5 μm. Despite forming a thinner coating layer with presumably reduced barrier properties, greening inhibition was still observed. This indicates that inhibition may not be solely due to film thickness or light-blocking capacity.

Without being bound by theory, one possible explanation is that the lower viscosity coating solution allowed more intimate contact with the tuber surface and, upon drying, may have partially covered lenticels. Alternatively, the ethanol component of the coating solution could have temporarily disrupted lenticel function during application. Both scenarios could reduce localized gas exchange and oxygen availability in the periderm, thereby slowing chlorophyll accumulation. Pre-light exposure of potatoes markedly reduces the anti-greening efficacy of zein-HPMC coatings. Therefore, coating should be applied within 12 h of light exposure to achieve optimal inhibition of greening. Furthermore, coatings prepared with lower polymer concentrations (0.8% w/w total polymer) remain effective. This unexpected result suggests that additional mechanisms may contribute to greening inhibition at low polymer concentrations. In particular, the dried polymer may have partially occluded lenticels, or the ethanol in the coating solution may have temporarily disrupted lenticel function, thereby reducing localized oxygen exchange. Collectively, the findings highlight the importance of both storage history and coating formulation in determining anti-greening performance.

### General Discussion—Various Embodiments

It will be appreciated that, based on the findings discussed above, the parameters required to produce and use anti-greening coatings may be generalized. The coating formulations are believed to interfere with the expression of enzymes or inhibit the enzymes involved in the chlorophyll biosynthesis pathway, such as glutamyl-tRNA reductase, porphobilinogen synthase, uroporphyrinogen decarboxylase, and magnesium chelatase, among others. When the ethanolic polymer solution is applied to the surface of potato tubers, although most of the ethanol in the solvent evaporates to the air during the coating formation process, a significant fraction of ethanol will diffuse across the periderm and into cortical parenchyma tissues where chlorophyll is synthesized. Since alcohol, such as ethanol used in the coating solution formulation, is known to denature proteins, it is reasonable to hypothesize that the ethanol in the formulation, besides acting as a solvent component to solubilize the ethanol- and aqueous ethanol-soluble polymers, also plays a role in deactivating the enzymes involved in chlorophyll synthesis pathway, thereby inhibiting chlorophyll biosynthesis and hence preventing greening of potato. An additional anti-greening effect can be attributed to the gas barrier properties of the dried coating that effectively reduces the availability of molecular oxygen in the air for the potato. Several intermediate steps of the chlorophyll biosynthesis pathway involve oxygen as the terminal electron acceptor, such as reactions involving coproporphyrinogen-III oxidase that catalyzes the oxidative decarboxylation of coproporphyrinogen-III to protoporphyrinogen-IX. Another intermediate step, which is catalyzed by protoporphyrinogen-IX oxidase, consists of the removal of two protons from the protoporphyrinogen-IX to form protoporphyrins IX, via passing the protons to molecular oxygen to produce water as a byproduct. By reducing the oxygen substrate needed in these oxidation reactions, the coating may have interfered with the biosynthesis of chlorophyll precursors, thereby delaying potato greening. Furthermore, the anti-greening effect can also be attributed to the light scattering properties of the dried coating. Therefore, it may be understood by the person skilled in the art that different embodiments of the anti-greening coat-forming solutions comprising at least one edible polymer dissolved in a compatible solvent may be considered as well. Generally, the components of the coating-forming solution are selected so that the resulting edible coatings formed after drying are substantially transparent for keeping the natural surface color, appearance, and texture of that of uncoated potatoes.

In some embodiments, the coat-forming solution comprises a total polymer concentration ranging from 0.1 to 10% (w/w). Some embodiments may comprise a single compatible solvent, while some embodiments may comprise a blend of different solvent compositions. The blend composition may comprise water and alcohol, for example with water: alcohol ratios ranging from 99.9:0.1 to 0.1:99.9.

In some embodiments, the alcohol may be selected from the group of water-soluble alcohols, such as ethanol, isopropanol, glycerol, propylene glycol, 1,3-butylene glycol, and combination thereof.

In some embodiments, the nature and concentration of the solubilized polymers in the compatible solvent are selected so that the polymers undergo partial phase separation upon the evaporation of the solvents during the formation of the coating, and for the resulting phase-separated entities in the coating at least partially scattering or blocking/absorbing light.

In some embodiments, the solubilized polymers may comprise a first group of one or more polymers soluble in aqueous alcohol, and/or a second group of one or more polymers soluble in water.

In some embodiments, the aqueous alcohol-soluble polymers may be selected from prolamin proteins such as zein, gluten, glutenin, gliadin, hordeins, avenins, secalins, kafirin, and combinations thereof.

In some embodiments, the water-soluble polymers may be selected from a group comprising water-soluble polysaccharides and water-soluble proteins.

In some embodiments, the water-soluble polysaccharides may be selected from a group comprising cellulose derivatives consisting of hydroxypropyl methylcellulose (HPMC), carboxymethyl cellulose, methylcellulose, and combination thereof.

In some embodiments, the water-soluble polysaccharides may be selected from a group consisting of starch, alginate, chitosan, pullulan, and similar.

In some embodiments, the water-soluble polysaccharides may similarly be soluble in aqueous alcohol.

In some embodiments, the water-soluble proteins may be selected from food proteins from meats (e.g., collagen, gelatin), dairy (e.g., casein, whey protein), pulses (e.g., lentils, chickpeas, kidney beans, peas, lentil, fava beans, mung beans), egg, and so on.

In some embodiments, the coat-forming solution may comprise only polysaccharides, only proteins, or a combination thereof.

In some embodiments, the coat-forming solution may comprise only zein, only HPMC, or a blend thereof.

In some embodiments, the HPMC solution comprises about 19% to about 30% methoxyl content and about 7% to about 12% hydroxypropoxyl content.

In some embodiments, edible coatings formed using HPMC alone, or a combination of HPMC and zein, tended to have improved physical properties (e.g., strength, adhesion, coherence, optical transparency). However, pure zein coatings, while still partially effective in preventing greening, are more brittle and may crack upon drying or handling. Nevertheless, edible coatings based on a single-polymer formulation may be as effective as that of a two-polymer formulation.

In some embodiments, the dried coating formed on the potato surface has the thickness range from 0.5 μm to 20 μm and weight ranging from 1 mg to 100 mg, for average tubers (measured via a sizing plate) ranging from 2 to 10 cm in diameter and weight ranging from 20 g to 350 g.

In some embodiments, an enhanced coat-forming solution includes food-grade additives for inhibiting sprouting in potato tubers.

In some embodiments, different means for applying the solution on the potatoes may be used, including without limitation: spraying, brushing, dipping, enrobing, or any combination thereof. Various application methods have been observed to significantly differ in anti-greening efficacies. For example, air gun spraying of the coating on potatoes yielded poor results, due to premature evaporation of ethanol as the solution was being atomized into fine droplets. In contrast, spraying the coating with low ethanol concentrations appeared to be more effective.

However, dipping provided best results due to enhanced coating coverage and increased ethanol skin contact time. It is believed that different application methods yield different polymer stratification behaviours due to different water/ethanol evaporation kinetics.

In some embodiments, the anti-sprouting additive may be selected from a group consisting of synthetic or naturally extracted compounds, such as 3-decen-2-one, carvone, D-limonene, or eugenol.

In some embodiments, the anti-sprouting additive may be selected from the group consisting of essential oils extracted from plants, such as those derived from Allium sativum (garlic), Anethum graveolens (dill), Carum carvi (caraway), Coriandrum sativum (coriander), Cymbopogon citratus (West Indian lemongrass), Cymbopogon nardus (citronella), Cymbopogon martini (palmarosa), Foeniculum vulgare (Fennel), Mentha piperita (peppermint), Mentha pulegium (mint), Mentha spicata (Spearmint), Origanum onites (Greek oregano), Ormenis mixta (Moroccan chamomile), Rosmarinus officinalis (rosemary), Vitis vinifera (grape) seed, or similar.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A method for delaying greening in a potato, comprising the steps of:
preparing a coat-forming solution comprising at least one edible polymer dissolved in a compatible solvent with a total concentration ranging from 0.1 to 10% (w/w), wherein the at least one edible polymer comprises polysaccharides, proteins, or any combination thereof;
applying an effective amount of the coat-forming solution on a surface of the potato; and
drying the effective amount of the coat-forming solution on the surface of the potato to form an anti-greening edible coating.

2. The method of claim 1, wherein the coat-forming solution comprises a polysaccharide and a protein.

3. The method of claim 1, wherein the polysaccharides are selected from a group consisting of: hydroxypropyl methylcellulose (HPMC), carboxymethylcellulose, methylcellulose, starch, alginate, chitosan, or pullulan.

4. The method of claim 1, wherein the proteins are selected from a group consisting of: zein, gluten, glutenin, gliadin, hordeins, avenins, secalins, or karifin.

5. The method of claim 1, wherein the compatible solvent comprises water, alcohol, or any combination thereof.

6. The method of claim 5, wherein the alcohol is selected from the group comprising ethanol, isopropanol, glycerol, propylene glycol, or 1,3-butylene glycol.

7. The method of claim 6, wherein the alcohol is selected based on an ability to deactivate enzymes involved in a chlorophyll synthesis pathway.

8. The method of claim 1, wherein the coat-forming solution undergoes at least a partial phase separation when drying.

9. The method of claim 1, wherein the coat-forming solution further comprises at least one food-grade additive that inhibits, at least in part, sprouting in potato tubers.

10. The method of claim 1, wherein the applying comprises dipping the potato into the coat-forming solution.

11. The method of claim 1, wherein the applying comprises spraying the coat-forming solution on the potato.

12. The method of claim 1, wherein the applying is completed within 12 hours after the potato is first exposed to light.

13. The method of claim 1, wherein the drying is completed at room temperature.

14. The method of claim 1, wherein the anti-greening edible coating is transparent.

15. The method of claim 1, wherein the anti-greening edible coating has a thickness ranging from about 0.5 μm to about 20 μm.

16. A food product for preventing greening of a potato comprising:
an anti-greening edible coating formed by applying and drying, on a surface of the potato, an effective amount of a coat-forming solution comprising at least one edible polymer dissolved in a compatible solvent with a total concentration ranging from 0.1 to 10% (w/w), wherein the at least one edible polymer comprises polysaccharides, proteins, or a combination thereof.

17. The food product of claim 16, wherein the coat-forming solution comprises a polysaccharide and a protein.

18. The food product of claim 16, wherein the polysaccharides are selected from a group consisting of: hydroxypropyl methylcellulose (HPMC), carboxymethylcellulose, methylcellulose, starch, alginate, chitosan, or pullulan.

19. The food product of claim 16, wherein the proteins are selected from a group consisting of: zein, gluten, glutenin, gliadin, hordeins, avenins, secalins, or karifin.

20. The food product of claim 16, wherein the compatible solvent comprises water, alcohol, or any combination thereof.

21. The food product of claim 20, wherein the alcohol is selected from the group comprising ethanol, isopropanol, glycerol, propylene glycol, or 1,3-butylene glycol.

22. The food product of claim 21, wherein the alcohol is selected based on an ability to deactivate enzymes involved in a chlorophyll synthesis pathway.

23. The food product of claim 16, wherein the coat-forming solution further comprises at least one food-grade additive that inhibits, at least in part, sprouting in potato tubers.

24. The food product of claim 16, wherein the anti-greening edible coating is transparent.

25. The food product of claim 16, wherein the anti-greening edible coating has a thickness ranging from about 0.5 μm to about 20 μm.

26. The food product of claim 16, wherein the anti-greening edible coating based on the combination of the polysaccharides and the proteins comprises a self-stratified coating of a plurality of edible polymers.

27. The food product of claim 16, wherein the anti-greening edible coating provides a gas barrier that, at least in part, reduces the availability of molecular oxygen for biosynthesis of chlorophyll precursors.

28. The food product of claim 16, wherein the anti-greening edible coating, at least in part, scatters light.

29. The food product of claim 16, wherein the anti-greening edible coating, at least in part, provides partial coverage of lenticels or temporary disruption of lenticels.
